(19) United States
(12) Patent Application Publication
(10) Pub. No.: US 2016/0270378 A1
(43) Pub. Date: Sep. 22, 2016

(54) SYSTEM FOR CLASSIFYING TINY INSECTS

(71) Applicant: NATIONAL TSING HUA UNIVERSITY, HSINCHU (TW)

(72) Inventors: RONG-SHUN CHEN, HSINCHU (TW); HUNG-YIN TSAI, HSINCHU (TW); CHIEN-HUNG LIN, HSINCHU (TW); HONG HOCHENG, HSINCHU (TW); WEI-LEUN FANG, HSINCHU (TW); ANN-SHYN CHIANG, HSINCHU (TW); YU-CHING LIN, HSINCHU (TW); JHIH-SHUN YANG, HSINCHU (TW); YU-CHENG WU, HSINCHU (TW); LI-AN CHU, HSINCHU (TW); CHIA-LIN WU, HSINCHU (TW)

(21) Appl. No.: 15/171,251

(22) Filed: Jun. 2, 2016

Related U.S. Application Data
(62) Division of application No. 13/419,184, filed on Mar. 13, 2012.

(51) Int. Cl. A01K 67/033; A01K 29/00

(52) U.S. Cl. CPC A01K 67/033; A01K 29/005

(57) ABSTRACT

A system for classifying tiny insects includes a cultivation tank, a detecting container, a detector, a gathering device, and a control unit. The cultivation tank is connected to the detecting container, so that the hatched tiny insects can enter the detecting area of the detecting container from the cultivation tank. The detector is used for detecting the characteristics of the tiny insects in the detecting area, and then the control unit controls the switching unit of the gathering device to switch the gathering containers for gathering the tiny insects according to the detecting results. The system of the present invention is capable of automatically classifying the tiny insects and then gathering them to different gathering containers according to their characteristics, so as to decrease the man power and time necessary for factitious classification.

### CROSS-REFERENCE TO RELATED APPLICATION

This application is a Divisional of co-pending U.S. patent application having Ser. No. 13/419,184, filed Mar. 13, 2012, which is incorporated herein by reference.

### BACKGROUND OF THE INVENTION

1. Field of the Invention

The present invention relates to a system for classifying tiny insects, and more particularly, to a system which can detect the characteristics of tiny insects automatically and determine the classifications or the sexes of tiny insects according to the detecting results.

2. Description of the Prior Art

Genetics is the science of genes, heredity, and variation in living organisms, and meanwhile genetics is an important branch of life science. For other branches, many of them are derived from the research of gene based on genetics, such as genetic engineering. Genetics not only plays a large role in the appearance and behavior of organisms but also can explain the macroscopic property of biological phenomenon with microscopic analysis. With the development and prosperity of genetic, the physiological problem, such as aging and disease, has been improved. Therefore, many researchers pay attention to the research of genes.

The genetic number of fruit flies is about one third of the number of human genes, however, the controlling gene of fruit flies is similar to the controlling gene of humanity in physical development, additionally, with the advantages of the short life cycle and mass reproduction, and fruit flies became popular model organisms in genetics research. So far, there are a lot of research about fruit flies in genetics, cell-biology, biochemistry, and especially developmental biology. Fruit flies made a greater contribution to genetics knowledge for almost a century.

In the genetic research of fruit flies, the researchers need to collect unbred female fruit flies, in order to confirm that the result of the genetics experimentation is accurate without any influence of male genes. To recognize unbred female fruit flies, the fruit fly should be fixed below the microscopy manually and then distinguish the abdominal characteristic in conventional method. Due to fruit flies breed abundantly and rapidly, and the female fruit flies take eight time to turn into sexual maturation after eclosion, it is necessary to keep on doing gender identification between the same interval so as to avoid fruit flies mating with each other. Otherwise, fruit flies are too small to be observed, so the researchers need to spend a large amount of money and time to adjust and improve the position of fruit fly for optimum observation. Therefore, it is really inefficient with the above method.

In addition to fruit flies, other research fields still need to implement with the above method, such as identifying the different insects or recognizing different characteristics of the same breed insect, thus other research fields have the same problem as the conventional method.

### SUMMARY OF THE INVENTION

Therefore, a scope of the invention is to provide a new type of system for classifying tiny insects which can determine the classification of the tiny insects automatically and improve the problems of the prior art.

According to an embodiment of the invention, the system for classifying tiny insects includes a cultivation tank, a detecting container, a detector, a gathering device, and a control unit. The cultivation tank is connected to the detecting container, so that the hatched tiny insects can enter the detecting area of the detecting container from the cultivation tank. The detector is used for detecting the characteristics of the tiny insects in the detecting area, and then the control unit controls the switching unit of the gathering device to switch the gathering containers for gathering the tiny insects according to the detecting results.

In the embodiment of the invention, the system for classifying tiny insects can classify the tiny insects automatically according to the characteristics detected by the detector, and collect the tiny insects into different gathering containers according to the classification of the tiny insects. Therefore, the system of the present invention can save the man power and time necessary for factitious classification, so that the system is more efficient than the prior art.

Many other advantages and features of the present invention will be further understood by the detailed description and the accompanying sheet of drawings.

### BRIEF DESCRIPTION OF THE APPENDED DRAWINGS

FIG. 1 is a schematic diagram illustrating a system for classifying tiny insects according to an embodiment of the invention.

FIG. 2 is a schematic diagram illustrating a system for classifying tiny insects according to another embodiment of the invention.

To facilitate understanding, identical reference numerals have been used, where possible to designate identical elements that are common to the figures.

### DETAILED DESCRIPTION OF THE INVENTION

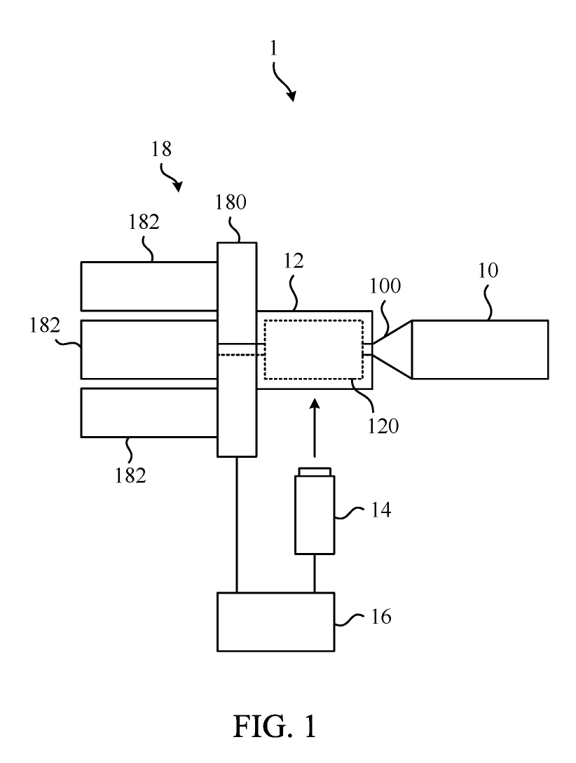

The invention discloses a system for classifying tiny insects. Please refer to FIG. 1. FIG. 1 is a schematic diagram illustrating a system for classifying tiny insects 1 according to an embodiment of the invention. As shown in FIG. 1, the system for classifying tiny insects 1 comprises a cultivation tank 10, a detecting container 12, a detector 14, a control unit 16, and a gathering device 18.

The cultivation tank 10 is used for storing and hatching the eggs of the tiny insects. For example, when the eggs of the same fruit fly are stored in the cultivation tank, proper environmental conditions (such as temperature or humidity) can be provided for hatching out the eggs. The cultivation tank 10 has a first opening 100, the fruit flies can leave the cultivation tank 10 through the first opening 100 after eclosion. In another embodiment, the cultivation tank 10 can be used for storing the adults of tiny insect, meanwhile, food or water can be supplied for lives of insects.

The first opening 100 of the cultivation tank 10 can be connected to the detecting container 12. The detecting container 12 comprises a detecting area 120 interconnected with the first opening 100. After leaving the cultivation tank 10 from the first opening 100, the tiny insects can enter the detecting area 120 so as to detect the tiny insects expediently. In another embodiment, the detecting container 12 can further comprise a confinement structure connected to the detecting area 120 to confine the tiny insects in the detecting area 120 so that the characteristics of tiny insects can be observed more easily. Moreover, the confinement structure may include, but not limited to, a physical constraint, such as restraining the tiny insects; or a chemical constraint, such as applying an anesthetic in the detecting area 120 to put the tiny insects into a stupor. Furthermore, the confinement structure can limit the number of the tiny insect in the detecting area, so as to avoid the misidentification.

When the tiny insects enter the detecting area 120, the detector 14 can observe and detect the characteristics of tiny insect within the detecting area 120. The detector 14 in the embodiment is an image detector or a camera, and the detector 14 can photograph the situation in the detecting area 120 at all times. Therefore, the detector 14 can obtain the appearance images of the tiny insects. In this embodiment, the detector 14 takes a photograph only in one direction; in actual application, the number of the detector 14 and the detecting direction in the detecting area 120 an be adjusted according to the needs of the user.

To be noticed, the detector 14 is used for detecting including, but not limited to, the appearance images of the tiny insects, and other characteristics according to the needs of the user. For example, while distinguishing the classifications or sexes of the tiny insects with different scents between male and female, the detector can be designed to detect the scents. In addition, the detector can detect the sounds of the tiny insects as its characteristics.

The control unit 16 is connected with the detector 14 so as to receive the characteristics detected by the detector 14, such as appearance images, scents, or sounds of the tiny insects. The control unit 16 can be a computer or an arithmetic system, so that the characteristics detected by the detector 14 can be used for classifying the tiny insects by the control unit 16. For example, the appearance images of tiny insects can be recognized by using image analysis; likewise, with the corresponding analytical methods, the scents or sounds of tiny insects can be recognized.

After the control unit 16 recognizing and classifying the tiny insects in the detecting area 120, the classified results can be stored into the data storage elements, and then the control unit 16 sends a control signal to the gathering device 18 according to the classified results, so as to control the gathering device 18 to gather the classified tiny insects. In addition, the gathering device 18 further comprises a switching unit 180 and a plurality of gathering containers 182, wherein the switching unit 180 can be connected with each gathering container 182, so as to interconnect one of the gathering containers 182 with the detecting area 120.

More specifically, after the control unit 16 sends a control signal to the gathering device 18 according to the classified results, the switching unit 180 can switch a certain gathering container 182 to interconnect with the detecting area 120 for gathering the tiny insects in the detecting container 182. Therefore, the classified tiny insects can be gathered into different containers respectively, and avoid being confused with the other types of insects. Additionally, the gathering containers comprises a first gathering container and a second gathering container, and the first gathering container is used for storing the same type of tiny insects classified by the control unit, and the second gathering container is used for collecting the tiny insects unclassified by the control unit.

For example, if the control unit 16 classifies the tiny insect as A-type (e.g., unbred female fruit flies) according to the characteristics detected by the detector 14, the switching unit 180 would switch an A-type gathering container 182 to interconnect with the detecting area 120 for gathering the A-type tiny insects. Or if the control unit 16 classifies the tiny insect as B-type (e.g., male fruit flies), the switching unit 180 would switch a B-type gathering container 182 to interconnect with the detecting area 120 for gathering the B-type tiny insects. Whereas, if the control unit 16 can not recognize which type the tiny insects belong to, the switching unit 180 would switch a X-type gathering container 182 to interconnect with the detecting area 120 for gathering the X-type tiny insects (i.e., unrecognized type).

In another embodiment, the gathering device further comprises an aspirator used for providing an attractive force to the detecting area, so as to suck the tiny insects into the gathering container. Wherein, the aspirator can be an air compressor for providing an air suction force to attract the tiny insect from the detecting area into the gathering container. Additionally, if the detecting container can not confine the tiny insects completely, driving factors can be applied to impel the tiny insect to enter the gathering container by the instincts. On the other hand, in order to prevent a classification failure, the openings of gathering containers can be closed, so that the other tiny insects can not enter the gathering containers when the detector works.

Please refer to FIG. 1 again, the cultivation tank 10 can be used for storing and hatching the eggs of the tiny insects in the embodiment. Take for instance fruit flies, the unbred female fruit flies take eight hours to turn into sexual maturation after eclosion, it is necessary to impel fruit flies to enter the detecting area 120 so as to avoid fruit flies mating with each other in the cultivation tank 10.

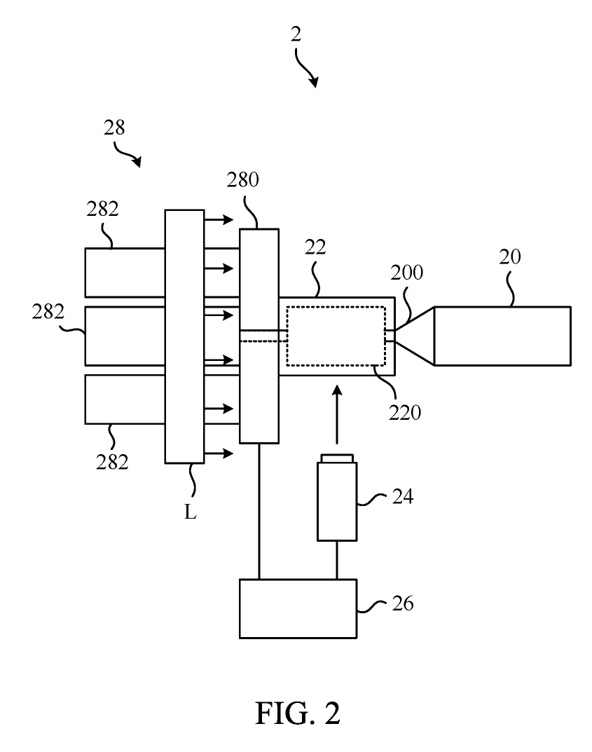

Please refer to FIG. 2, FIG. 2 is a schematic diagram illustrating a system for classifying tiny insects 2 according to another embodiment of the invention. As shown in FIG. 2, the difference between the embodiment in this figure and the above embodiment is that the system for classifying tiny insects 2 in the embodiment further comprises an impelling device (i.e., lighting module L), the lighting module L can emit a light as a driving factor toward the cultivation tank 20 and the detecting container 22. Due to the phototropism of certain tiny insects, the tiny insects would be attracted by light source and then enter the detecting area 220 of the detecting container 22. The units of the embodiment mentioned previously and the units in this embodiment are in essence the same, thus the steps needn't be elaborate any further.

The driving factors include but not limit to the light source in the embodiment mentioned previously. In actual application, a variety of driving factors can be applied to different types of tiny insects according to their biological instincts. For example, the impelling device can comprise a scent-producer so as to attract the scent-sensitive insects into the detecting area. Moreover, a magnetic field generator can be applied to the cultivation tank, so that the tiny insects with magnetotaxis are impelled to enter the detecting area. Furthermore, for the tiny insects with all the instincts described above, the impelling device can provide multiple driving factors to impel the tiny insects to leave the cultivation tank, such as light source, scents, and/or magnetic.

The impelling device and the aspirator in the embodiments mentioned previously can be linked to and controlled by the control unit, i.e., with the control unit, the processes from detecting, classifying, to gathering can proceed with automatic control.

According to the above, the invention is to provide a system for classifying tiny insects. The system impels tiny insects to enter the detecting area by the impelling device, and then the tiny insects can be detected by the detector automatically, finally, the tiny insects are classified and gathered into different gathering containers according to the detecting results. Additionally, the processes mentioned above can proceed by the control unit automatically. Compared to the prior art, the invention can classify the tiny insects more efficiently, so as to decrease the man power and resource consumption for factitious classification.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A system for classifying tiny insects used for classifying at least one tiny insect, the system comprising:
a cultivation tank for storing the at least one tiny insect further comprising a first opening for the at least one tiny insect leaving the cultivation tank;
a detecting container further comprising a detecting area, wherein the detecting area is interconnected with the first opening of the cultivation tank, so as to receive the at least one tiny insect leaving from the first opening;
a detector for detecting a characteristic of the at least one tiny insect in the detecting area;
a gathering device comprising a switching unit and a plurality of gathering containers, wherein the switching unit is used for switching the gathering containers, so as to interconnect one of the gathering containers with the detecting area for gathering the at least one tiny insect in the detecting container; and
a control unit connected to the detector and the switching unit, wherein the control unit controls the switching unit according to the characteristic detected by the detector.

2. The system for classifying tiny insects of claim 1 further comprises an impelling device providing a driving factor to impel the at least one tiny insect to leave the cultivation tank from the first opening.

3. The system for classifying tiny insects of claim 2, wherein the impelling device comprises a lighting module, a scent-producer, or a magnetic field generator, and the driving factor comprises light source, scents, or magnetic.

4. The system for classifying tiny insects of claim 1, wherein the switching unit further comprises an aspirator providing an attractive force to attract the at least one tiny insect from the detecting area to the gathering container.

5. The system for classifying tiny insects of claim 4, wherein the aspirator is an air compressor, and the attractive force is an air suction force.
